(19) United States
(12) Patent Application Publication
(10) Pub. No.: US 2007/0094239 A1
(43) Pub. Date: Apr. 26, 2007

(54) COMMUNICATING PART NUMBER DETAIL DATA BETWEEN ENTERPRISE AND PART SUPPLIER

(75) Inventors: Giacomo J. Catucci, Clinton Corners, NY (US); Robert E. Cremins, Poughkeepsie, NY (US); Larry S. Dahl, Beacon, NY (US); Alfredo Fappiano, Torrington, CT (US); Vincent J. Giancaspro, Wappingers Falls, NY (US); Michael Lauri, Montgomery, NY (US); Denise M. O'Shea, Hopewell Junction, NY (US); Joel K. Popelsky, Highland Mills, NY (US)

Correspondence Address: HOFFMAN, WARNICK & D'ALESSANDRO LLC, 75 STATE ST, 14TH FL, ALBANY, NY, 12207, US

(73) Assignee: INTERNATIONAL BUSINESS MACHINES CORPORATION, ARMONK, NY (US)

(21) Appl. No.: 11/163,531

(22) Filed: Oct. 21, 2005

(51) Int. Cl. G06F 17/30

(52) U.S. Cl. 707/3

(57) ABSTRACT

A method, system and program product for communicating part data between an enterprise and a particular supplier of a plurality of suppliers to the enterprise are disclosed. In one embodiment, the invention provides a part number library database at the enterprise including part number detail data regarding a plurality of parts to be procured from the plurality of suppliers. The part number library database is used to generate a part number detail document file including all part number detail documents for the particular supplier, and a part number detail document add/change file including any new part number detail documents and any changed part number detail documents compared to a last generation of the part number detail document file for the particular supplier. The two files are then communicated to the particular supplier. Hence, the invention reduces duplicative work at the enterprise and ensures that the enterprise and the supplier are up-to-date on part information.

### BACKGROUND OF THE INVENTION

1. Technical Field

The invention relates generally to supply and demand management, and more particularly, to a method, system and program product to enable an enterprise to automatically communicate the initial definition and ongoing change detail of a part, planned to be procured, to one or more approved suppliers using pre-existing information stored within the enterprise's part number library database.

### BACKGROUND ART

Many products and services include numerous parts or components that the producing original equipment manufacturer (OEM) or service provider (collectively referred to herein as an ‘enterprise’) selects in order to achieve its end product or service design and market objectives. For example, typical electronic or mechanical hardware products include numerous parts. The specification, cost, quality, reliability, performance and supply availability of these components will ultimately dictate the success of the end product in the marketplace and the profitability of the enterprise. The vast majority of enterprises do not manufacture most of the parts or components used within their end products. Instead, these parts are procured from various other companies or suppliers who specialize in the development, manufacturing and sale of their individual component types. Given the obvious importance of procured parts to the success of the end product, most enterprises have procurement and/or supply chain specialists who are assigned to manage all aspects of procured parts. These procurement personnel manage all required communication and relationships with the component suppliers including specifications, costs, contracts, qualifications, quality, supply chain logistics and problem solving.

One of the important tasks managed by these procurement personnel is the creation and communication of a specification or definition that clearly describes all requirements and expectations of each procured part. Within a typical enterprise, for example, the definition and requirements of each individual procured component are assigned a unique identifiable part number. This part number is typically used within all of the enterprise's product data management and manufacturing systems and associated processes including end product structure definition, usage tracking and forecasting. The procurement task of creating, maintaining, tracking, and communicating these part numbers and their associated requirements is both the starting point and an ongoing integral piece of insuring the success of these processes and ultimately the enterprise end product.

Referring to FIG. 1, a flow diagram of one conventional process is illustrated. In step S1, a new part requirement or change to an existing part number is identified. In step S2, the new part number is created or the existing part number is changed. There may be five sub-steps to these tasks: First, in order to create a new part number definition the procurement team must interface with the enterprise's design and manufacturing personnel to understand all specific end products and manufacturing requirements for the part. If after a review of requirements versus pre-existing part numbers, it is deemed that a new part number is required, several items must be identified for inclusion into the definition of a new part number. In one example, a new part number may require: A) allowable suppliers, B) supplier part number and associated specification, C) customization requirement(s), D) general specifications for procurement, manufacturing, handling, shipping and quality, and E) other generic specifications.

In terms of allowable suppliers, in most cases, procurement, manufacturing and design personnel will work together to select, qualify and approve one or multiple suppliers for each procured part number. In terms of supplier part number and associated specification, in many cases, the procured part definition will be largely based on a specification published by one or more of the approved suppliers in their catalogs. This specification will be associated with a unique supplier part number assigned by each supplier and listed in their catalog. In some cases, unique enterprise application requirements may dictate the need to customize by changing or adding to the published supplier part number specifications. In addition, the enterprise may request that suppliers perform additional testing of their component prior to shipment to order to insure some specific aspect of performance, quality or reliability. Changes to published supplier specifications and/or additional test requirements must be clearly defined in the enterprise part number definition. Every typical enterprise also has a set of general requirements used to govern the procurement, manufacturing, handling, shipping and general quality of procured parts or components. These requirements typically are defined in one or more general specifications created and maintained by the enterprise's procurement team and must be included in the definition of each part number to be applicable. As industry, government regulatory and/or business requirements change, an enterprise may need to generate new generic specifications to support these changes and insure that procured parts meet new requirements. Again, such generic specifications are typically created and maintained by the enterprise's procurement team and must be included in the definition of each part number to be applicable.

In step S3, the part number is loaded into the enterprise's part number library database. enterprises with numerous end product designs will quickly create a large library of part numbers, which can ideally be used repeatedly in new and different enterprise products. In most cases, a part number library database is needed to maintain some level of definition associated with each part number and avoid re-creating part numbers which may already exist. The part number library database is typically an electronic system made available to all design, manufacturing, financial and procurement personnel within the enterprise who may have a need to understand part number detail for past, current or potential future use and re-use.

In step S4, a controlling document is created, which includes all of the above-described detail. The document serves the purpose of listing all requirements for the review and understanding of all parties involved including those within the enterprise and approved supplier companies. This controlling document is often referred to as the ‘part number detail’ document.

In step S5, procurement personnel must communicate the part number detail document to all approved suppliers so that they know what they are expected to manufacture and provide to the enterprise. In addition, the timely communication of this detail is critical to insure supplier support of new enterprise product manufacturing start-up schedules.

In step S6, a pre-existing part number definition may require a revision to support application, supplier or business dynamics, which will also dictate revision of the part number detail document. As a result, an enterprise must have some method of proper revision control and management of part number detail documents to insure that all parties are aware of and using the latest revision, and the part number library database is updated accordingly.

All of the steps of FIG. 1 must be completed properly and synchronized in order to define a new or changed enterprise procured part number. One challenge in achieving this, however, is the fact that most enterprises face dramatically reduced resources, compressed development schedules and rapid product launch requirements that are characteristic of today's marketplace. The above-described process, although necessary, is quite cumbersome, inefficient, time consuming and also prone to error. For example, once understood, the actual detail associated with the specifications of a procured part must be documented both in a part number detail document for communication with suppliers and within the enterprise's part number library database. These tasks are somewhat redundant but necessary given the target usage for each of these vehicles. In addition, whenever a new part number needs to be created or an existing part number revised, the enterprise must have a process to insure both the part number detail document and the part number library database are updated simultaneously. This process is often very administrative in nature, causing some personnel to attempt to bypass it altogether, or completely dependent on personnel, which makes it prone to human error. In either case, mismatches can be disastrous.

The above-described challenges are also magnified by the inclusion of the other party, the supplier. In particular, the redundancy and inefficiency is further expanded since each supplier must maintain a copy of the latest revision of the enterprise's part number detail document and recreate all requirements in its own internal detail document and database systems. Depending upon the efficiency of the new part or change communication process, a new part number or update/revision of an existing part number may be considered complete and in effect by the enterprise but may not yet be implemented or even received by the supplier. Such a mismatch could cause extreme difficulty especially in a complex or high speed, on demand, supply chain. In addition, this time consuming process adds cost to the procured part and also ultimately to the product.

As a result, the process of physically revising part number detail documents, obtaining a legitimate revision level in accordance with an enterprise's revision control process and communicating new revision detail to suppliers can easily become over burdened with administrative requirements. Again, the inclusion of one or more suppliers in this process further complicates the situation, especially if there is a disagreement in the content of a new or revised part number detail document between the enterprise and the supplier. Depending upon the flexibility of the situation and the enterprise's revision control process, a disagreement may require a complete restart of the part number revision process. Individual procurement personnel are challenged to manage this process, often for thousands of part numbers in a rapid fashion. Daily business pressures may force personnel to attempt ‘short cuts’ which could easily result in errors. In the worst case scenario, the definition of a procured part may be inadequate or improperly created. Obviously, an undetected error or deficiency in the definition of a procured part could severely impact the performance of the end using product, the enterprise and perhaps even the end consuming customer.

In view of the foregoing, there is a need in the art for a process in which part number definitions and change detail are created and maintained in a reliable, dedicated, non-redundant location which is accessible by all enterprise personnel and automatically communicated to approved suppliers for their review and implementation.

### SUMMARY OF THE INVENTION

A method, system and program product for communicating part data between an enterprise and a particular supplier of a plurality of suppliers to the enterprise are disclosed. In one embodiment, the invention provides a part number library database at the enterprise including part number detail data regarding a plurality of parts to be procured from the plurality of suppliers. The part number library database is used to generate a part number detail document file including all part number detail documents for the particular supplier, and a part number detail document add/change file including any new part number detail documents and any changed part number detail documents compared to a last generation of the part number detail document file for the particular supplier. The two files are then communicated to the particular supplier. Hence, the invention reduces duplicative work at the enterprise and ensures that the enterprise and the supplier are up-to-date on part information.

A first aspect of the invention provides a method of communicating part data between an enterprise and a particular supplier of a plurality of suppliers to the enterprise, the method comprising the steps of: providing a part number library database, the part number library database including part number detail data regarding a plurality of parts to be procured from the plurality of suppliers; generating, using the part number library database, a part number detail document file including all part number detail documents for the particular supplier; generating a part number detail document add/change file including any new part number detail documents and any changed part number detail documents compared to a last generation of the part number detail document file for the particular supplier; and communicating the part number detail document file and the part number detail document add/change file to the particular supplier.

A second aspect of the invention provides a system for communicating part data between an enterprise and a particular supplier of a plurality of suppliers to the enterprise, the system comprising: a part number library database, the part number library database including part number detail data regarding a plurality of parts to be procured from the plurality of suppliers; a file generator for generating, using the part number library database: a) a part number detail document file including all part number detail documents for the particular supplier, and b) a part number detail document add/change file including any new part number detail documents and any changed part number detail documents compared to a last generation of the part number detail document file for the particular supplier; and a communicator for communicating the part number detail document file and the part number detail document add/change file to the particular supplier.

A third aspect of the invention provides a program product stored on a computer-readable medium, which when executed, communicates part data between an enterprise and a particular supplier of a plurality of suppliers to the enterprise, the enterprise including a part number library database, the part number library database including part number detail data regarding a plurality of parts to be procured from the plurality of suppliers, the program product comprising: program code for generating, using the part number library database, a part number detail document file including all part number detail documents for the particular supplier; program code for generating a part number detail document add/change file including any new part number detail documents and any changed part number detail documents compared to a last generation of the part number detail document file for the particular supplier; and program code for communicating the part number detail document file and the part number detail document add/change file to the particular supplier.

A fourth aspect of the invention provides a method of maintaining part data for a supplier to an enterprise, the method comprising the steps of: receiving, at the supplier, a part number detail document file including all part number detail documents for the supplier and a part number detail document add/change file including any new part number detail documents and any changed part number detail documents from a last communication of the part number detail document file; and updating the part data at the supplier based on the part number detail document file and the part number detail document add/change file.

A fifth aspect of the invention provides a computer-readable medium that includes computer program code to enable a computer infrastructure to communicate part data between an enterprise and a particular supplier of a plurality of suppliers to the enterprise, the computer-readable medium comprising computer program code for performing the method steps of the invention.

A sixth aspect of the invention provides a business method for communicating part data between an enterprise and a particular supplier of a plurality of suppliers to the enterprise, the business method comprising: managing a computer infrastructure that performs each of the steps of the invention; and receiving payment based on the managing step.

A seventh aspect of the invention provides a method of generating a system for communicating part data between an enterprise and a particular supplier of a plurality of suppliers to the enterprise, the method comprising: obtaining a computer infrastructure; and deploying means for performing each of the steps of the invention to the computer infrastructure.

The illustrative aspects of the present invention are designed to solve the problems herein described and other problems not discussed, which are discoverable by a skilled artisan.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows a conventional method of communicating part data between an enterprise and a supplier.

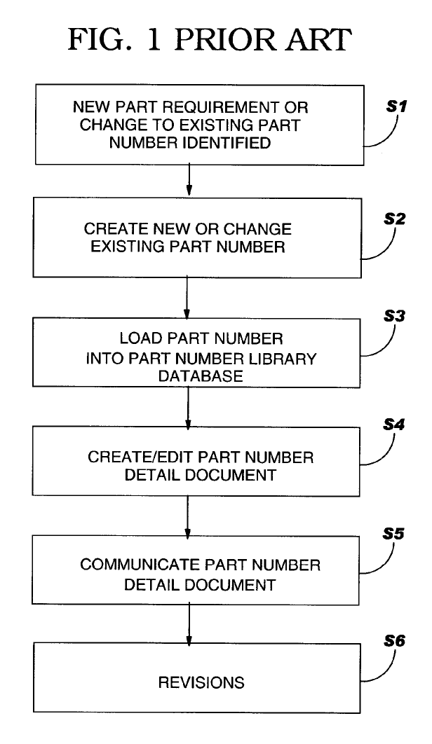

FIG. 2 shows a block diagram of a system for communicating part data between an enterprise and a particular supplier of a plurality of suppliers to the enterprise according to the invention.

FIG. 3 shows a flow diagram of one embodiment of operation of the system of FIG. 2.

FIG. 4 shows a flow diagram of an alternative embodiment of operation of the system of FIG. 2.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION

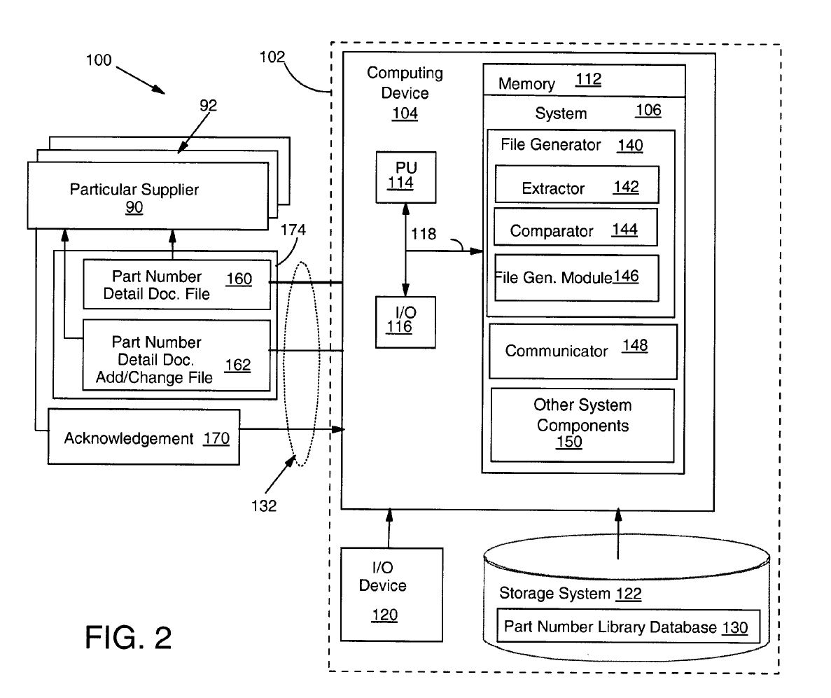

Turning to the drawings, FIG. 2 shows an illustrative environment 100 for communicating part data between an enterprise (at computer infrastructure 102) and a particular supplier 90 of a plurality of suppliers 92 to the enterprise. As used herein, “enterprise” includes any type of entity that requires tracking of parts of a product and/or service to be provided to a customer and supplied by various outside suppliers. Environment 100 includes a computer infrastructure 102 that can perform the various process steps described herein for communicating part data. In particular, computer infrastructure 102 is shown including a computing device 104 that comprises a system 106, which enables computing device 104 to communicate part data between an enterprise and particular supplier 90 of plurality of suppliers 92 to the enterprise by performing the process steps of the invention.

Computing device 104 is shown including a memory 112, a processor (PU) 114, an input/output (I/O) interface 116, and a bus 118. Further, computing device 104 is shown in communication with an external I/O device/resource 120 and a storage system 122. As is known in the art, in general, processor 114 executes computer program code, such as system 106, that is stored in memory 112 and/or storage system 122. While executing computer program code, processor 114 can read and/or write data, such as system 106, to/from memory 112, storage system 122, and/or I/O interface 116. As will be described in greater detail below, storage system 122 may include a part number library database 130. Bus 118 provides a communications link between each of the components in computing device 104. 1/0 device 11 8 can comprise any device that enables a user to interact with computing device 104 or any device that enables computing device 104 to communicate with one or more other computing devices.

In any event, computing device 104 can comprise any general purpose computing article of manufacture capable of executing computer program code installed by a user (e.g., a personal computer, server, handheld device, etc.). However, it is understood that computing device 104 and system 106 are only representative of various possible equivalent computing devices that may perform the various process steps of the invention. To this extent, in other embodiments, computing device 104 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively.

Similarly, computer infrastructure 102 is only illustrative of various types of computer infrastructures for implementing the invention. For example, in one embodiment, computer infrastructure 102 comprises two or more computing devices (e.g., a server cluster) that communicate over any type of wired and/or wireless communications link, such as a network, a shared memory, or the like, to perform the various process steps of the invention. When the communications link comprises a network, the network can comprise any combination of one or more types of networks (e.g., the Internet, a wide area network, a local area network, a virtual private network, etc.). Regardless, communications between the computing devices may utilize any combination of various types of transmission techniques.

Each particular supplier 90 is shown in communication with computing device 104 over a communications link 132. Communications link 132 can comprise any combination of various types of communications links as is known in the art. In one embodiment, each particular supplier 90 includes a computing device that is in communication with computing device 104 over the Internet or a secured network. Regardless, it is understood that each particular supplier 90 can comprise the same components (processor, memory, I/O interface, etc.) as shown for computing device 104. These components have not been separately shown and discussed for brevity.

As previously mentioned and discussed further below, system 106 enables computing infrastructure 102 to communicate part data between an enterprise and particular supplier 90 of a plurality of suppliers 92 to the enterprise. To this extent, system 106 is shown including a file generator 140 including an extractor 142, a comparator 144 and a file generating (gen.) module 146; a communicator 148 and other system components 150. Other system components 150 may include other functionality necessary for operation of system 106 but not expressly described herein. Operation of each of these systems is discussed further below. However, it is understood that some of the various functions shown in FIG. 2 can be implemented independently, combined, and/or stored in memory for one or more separate computing devices that are included in computer infrastructure 102. Further, it is understood that some of the functionality may not be implemented, or additional systems and/or functionality may be included as part of environment 100. System 106 may be provided as a separate system or may be integrated with a larger procurement system.

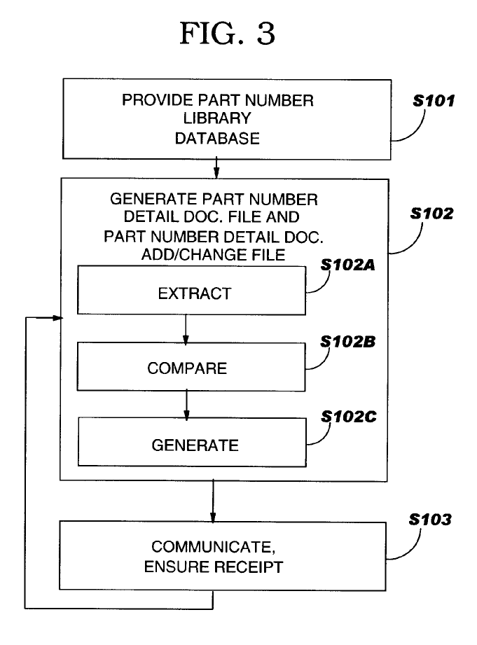

Turning to FIG. 3, in conjunction with FIG. 2, one embodiment of operation of system 106 will now be described. In a first step S101, a part number library database 1 30 is provided at the enterprise. Part number library database 130 includes data regarding a plurality of parts to be procured from the plurality of suppliers 92. In one embodiment, part number library database 130 is a conventional electronic system made available to all design, manufacturing, financial and procurement personnel within the enterprise who may have a need to understand part number detail for past, current or potential future use and re-use. Part number library database 130 may include, for example, the following data elements for each part number: A) allowable suppliers, B) supplier part number and associated specification, C) customization requirement(s), D) general specifications for procurement, manufacturing, handling, shipping and quality, and E) other generic specifications. In addition, each part number may further include a supplier contact, e.g., an e-mail address for a supplier contact.

In step S102, file generator 140 generates a part number detail document (doc.) file 160 including all part number detail documents for the particular supplier using part number library database 130. As described above, a part number detail document is a controlling document that includes data elements such as: supplier name, supplier part number(s), enterprise contact, enterprise part number, part type, any customization requirement, at least one specification, an add/change date and perhaps other data, as will be described in greater detail below. In addition, as a part of step S102, file generator 140 generates a part number detail document add/change file 162 including any new part number detail documents and any changed part number detail documents compared to a last generation of part number detail document file 160 for particular supplier 90.

In one embodiment, in sub-step S102A, extractor 142 extracts all part number detail data for particular supplier 90 from part number library database 130. That is, extractor 142 searches part number library database 130 for all part number detail data supplied by particular supplier 90 to the enterprise. The extraction step can be based on, for example, a supplier name and searching an approved supplier list data element within part number library database 130. In this fashion, multiple electronic part number detail documents that must be communicated to the same approved supplier can be grouped together in a common electronic format. The part number detail data extracted may include, for example, for each part: unique enterprise part number assigned by the enterprise for the part; part number creation date in database 130; enterprise procurement contact responsible for part number creation and maintenance; supplier name; supplier contact address (e.g., e-mail address); corresponding supplier part number published in supplier catalog with specifications; part type including a generic description or categorization of the part; any customization requirements, e.g., changes to published supplier part number specifications and/or additional enterprise test requirements (this field can be blank if there are no customization requirements); and any other data elements required by the enterprise and/or supplier. This part number detail data is used to form each part number detail document, which may include each ‘dynamic’ (i.e., changeable with each part number) data element listed above (excepting perhaps supplier contact address). The part number detail documents may also contain one or more ‘static’ data elements, which need not be maintained in or extracted from the enterprise's part number library database 130 because they do not frequently change. Static data elements may include, for example, at least one specification such as document numbers of generic specifications that describe details needed to comply with specific industry, government regulatory and/or business standards or a document including the enterprise's procurement, manufacturing, handling, shipping and/or quality expectations. Also, if required, the part number detail document can be a predefined translation of one or more related dynamic data elements in the enterprise's part number library database 130. Each part number detail document may also include an ‘add/change date’ and will contain the date that the record first appeared in the part number detail document file or the date when the record was last changed, which ever date is more recent. The add/change date is not extracted from part number library database 130, but is automatically and dynamically generated for each electronic part number detail document for each supplier by extractor 142. This will enable each particular supplier 90 to quickly identify when the last change on the part number had occurred.

In sub-step S102B, comparator 144 compares the part number detail data to a previous extract of all part number detail data for particular supplier 90 to determine any additional part number detail documents and any changed part number detail documents. That is, any new part number detail data added to part number library database 130 and any changed part number detail data in part number library database 130 are identified by comparing the current extraction to a previous extraction. Comparator 144 provides an indication of the status, i.e., if the part number is new, an indication such as ‘NEW PART NUMBER’ is indicated, and if the part number has a change, an indication such as ‘CHANGE’ is indicated.

In sub-step S102C, file generating module 146 generates part number detail document file 160 and part number detail document add/change file 162. Each part number detail document file 160 may include one or more part number detail documents, as described above, for particular supplier 90. Each part number detail document add/change file 162 includes zero or more added or changed part number detail documents. For example, in one embodiment, part number detail document add/change file 162 may include: new part numbers which were not in the previous part number detail document file 160 sent to particular supplier 90. These new part numbers would be newly created ‘part numbers’ or situations where a supplier has been newly listed as approved for an existing part number within the enterprise's part number library database 130. In addition, part number detail document add/change file 162 may include existing part numbers where one or more of the ‘dynamic’ data elements has changed from the previous part numbers detail document file 160 sent to particular supplier 90. Part number detail document add/change file 162 may further include for each part number, the same content and titles as part numbers detail document file 160, except perhaps for the ‘add/change date’ which could be replaced with a notation entitled ‘adds/changes’. If the part number is new, an indication such as ‘NEW PART NUMBER’ will appear with the ‘adds/changes’ notation. If the part number has a change, an indication such as ‘CHANGE’ will appear with the ‘adds/changes’ notation. Again, comparator 144 performs these compares and outputs this data. In the case that comparator 144 determines that no part number detail document changes or additions are present, then file generating module 146 generates an empty part number detail document add/change file 162 and may include a notation such as ‘NO ADDITIONS OR CHANGES FOR THIS PERIOD’. In one alternative embodiment, file generating module 146 may generate part number detail document file 160 after sub-step S102A, rather than wait for sub-step S102B. In any event, part number detail document file 160 and part number detail document add/change file 162 are preferably in a standard information interchange format, e.g., ASCII, spreadsheet (e.g., Microsoft@ Excel@, Lotus@ 123), comma or tab separated values, etc.

In step S103, communicator 148 communicates part number detail document file 160 and part number detail document add/change file 162 to particular supplier 90. In one embodiment, communicator 148 includes an e-mail system for electronically mailing part number detail document file 160 and part number detail document add/change file 162 to particular supplier 90, preferably in a single e-mail message 174. As noted above, each particular supplier 90 contact's mail address may be provided as a data element for each part number in part number library database 130. Step S103 also may include communicator 148 ensuring receipt by particular supplier 90. In one embodiment, communicator 148 may create a mailing including an electronic ‘button’ or equivalent electronic means which, once triggered by particular supplier 90 upon receipt of the mailing, will send an electronic acknowledgement 170 to system 106 which will record which supplier(s) has received the mailing. It is understood that electronic acknowledgement 170 may take any of a variety of forms, e.g., an automatic e-mail read receipt, an electronic response to selection of a hypertext link in the communication, a selection of a receipt button in the communication, etc. Received electronic acknowledgement 170 may be stored in storage system122. With this data stored, system 106 can create a report on demand, portraying the instantaneous or ongoing responsiveness of all or selected suppliers.

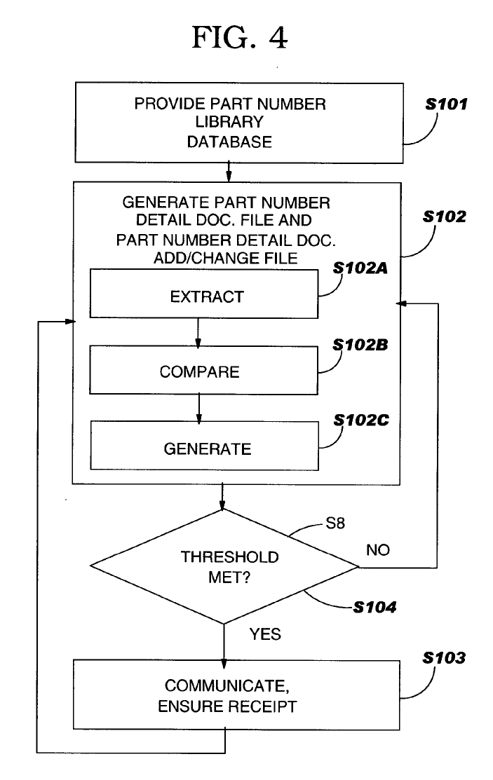

In an alternative embodiment, shown in FIG. 4, in a step S104 preceding communication step S103, communicator 148 may disable communication with particular supplier 90, in the case that a threshold has not been met. The threshold may be user-defined such as volume delivery achievement to the enterprise or other business-related parameters, e.g., supplier financial stability, etc.

The above-described system 106 eliminates several, previously required, but redundant process steps while simultaneously improving the reliability, increasing the efficiency and reducing the cost of the overall process. In addition, multiple groups of electronic part number detail documents, which represent all or a portion of the enterprise's part number library, can be automatically created, separated by supplier and electronically mailed to each supplier at predefined intervals. Updates or changes from the previous electronic mailing can be automatically identified in each new electronic mailing so that each supplier can clearly identify newly created part numbers or changes to existing part numbers. Part number detail document file 160 ensures that the enterprise and its suppliers have continually synchronized records of all part numbers; and part number detail document add/change file 162 enables rapid identification of new part numbers and changes to existing part numbers by suppliers. The frequency for sending a new set of files can be set depending upon the anticipated part number creation and change churn within the enterprise, e.g., once per week on a pre-defined day. System 106 also only requires new part numbers or changes to existing part numbers to be input into part number library database 130, rather than database 130 and a part number detail document individually. Electronic part number detail documents or changes to pre-existing drawings will be automatically created and communicated to suppliers. Procurement or other personnel responsible for this process need only track periodic supplier receipt of these electronic part number detail documents.

It is understood that the order of the above-described steps is only illustrative. To this extent, one or more steps can be performed in parallel, in a different order, at a remote time, etc. Further, one or more of the steps may not be performed in various embodiments of the invention.

While shown and described herein as a method and system for communicating part data between an enterprise and a particular supplier of a plurality of suppliers to the enterprise, it is understood that the invention further provides various alternative embodiments. For example, in one embodiment, the invention provides a computer-readable medium that includes computer program code to enable a computer infrastructure to communicate part data between an enterprise and a particular supplier of a plurality of suppliers to the enterprise. To this extent, the computer-readable medium includes program code, such as system 106 (FIG. 2), which implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 112 (FIG. 2) and/or storage system 122 (FIG. 2) (e.g., a fixed disk, a read-only memory, a random access memory, a cache memory, etc.), and/or as a data signal traveling over a network (e.g., during a wired/wireless electronic distribution of the program code).

In another embodiment, the invention provides a business method that performs the process steps of the invention on a subscription, advertising, and/or fee basis. That is, a service provider, such as an Application Service Provider, could offer to communicate part data between an enterprise and a particular supplier of a plurality of suppliers to the enterprise as described above. In this case, the service provider can manage (e.g., create, maintain, support, etc.) a computer infrastructure, such as computer infrastructure 102 (FIG. 2), that performs the process steps of the invention for one or more customers. In return, the service provider can receive payment from the customer(s) under a subscription and/or fee agreement and/or the service provider can receive payment from the sale of advertising space to one or more third parties.

In still another embodiment, the invention provides a method of generating a system for communicating part data between an enterprise and a particular supplier of a plurality of suppliers to the enterprise. In this case, a computer infrastructure, such as computer infrastructure 102 (FIG. 2), can be obtained (e.g., created, maintained, having made available to, etc.) and one or more systems for performing the process steps of the invention can be obtained (e.g., created, purchased, used, modified, etc.) and deployed to the computer infrastructure. To this extent, the deployment of each system can comprise one or more of: (1) installing program code on a computing device, such as computing device 104 (FIG. 2), from a computer-readable medium; (2) adding one or more computing devices to the computer infrastructure; and (3) incorporating and/or modifying one or more existing systems of the computer infrastructure, to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after any combination of the following: (a) conversion to another language, code or notation; (b) reproduction in a different material form; and/or (c) decompression. To this extent, program code can be embodied as one or more types of program products, such as an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

What is claimed is:

1. A method of communicating part data between an enterprise and a particular supplier of a plurality of suppliers to the enterprise, the method comprising the steps of:
providing a part number library database, the part number library database including part number detail data regarding a plurality of parts to be procured from the plurality of suppliers;
generating, using the part number library database, a part number detail document file including all part number detail documents for the particular supplier;
generating a part number detail document add/change file including any new part number detail documents and any changed part number detail documents compared to a last generation of the part number detail document file for the particular supplier; and
communicating the part number detail document file and the part number detail document add/change file to the particular supplier.

2. The method of claim 1, further comprising the step of ensuring receipt by the particular supplier.

3. The method of claim 2, wherein the ensuring step includes receiving an electronic acknowledgement from the particular supplier.

4. The method of claim 1, wherein the part number detail document add/change file generating step includes:
extracting all part number detail data for the particular supplier from the part number library database;
comparing the part number detail data to a previous extract of all part number detail data for the particular supplier to determine any new part number detail documents and any changed part number detail documents; and
generating the part number detail document add/change file based on the comparing step.

5. The method of claim 4, wherein, in the case that the comparing step determines that no part number detail data changes or additions are present, then the generating step generates an empty part number detail document add/change file.

6. The method of claim 1, wherein the part number detail document file includes: supplier name, supplier part number, enterprise contact, enterprise part number, part type, any customization requirement, at least one specification and an add/change date.

7. The method of claim 1, wherein the part number detail document file and the part number detail document add/change file are in a standard information interchange format.

8. The method of claim 1, further comprising the step of disabling communication with the particular supplier, in the case that a threshold has not been met.

9. A method of generating a system for communicating part data between an enterprise and a particular supplier of a plurality of suppliers to the enterprise, the method comprising:
obtaining a computer infrastructure; and
for each of the steps of claim 1, deploying a means for performing the step to the computer infrastructure.

10. A computer-readable medium for enabling a computer infrastructure to communicate part data between an enterprise and a particular supplier of a plurality of suppliers to the enterprise, the computer-readable medium comprising computer program code for performing the method steps of claim 1.

11. A system for communicating part data between an enterprise and a particular supplier of a plurality of suppliers to the enterprise, the system comprising:
a part number library database at the enterprise, the part number library database including part number detail data regarding a plurality of parts to be procured from the plurality of suppliers;
a file generator for generating, using the part number library database:
a) a part number detail document file including all part number detail documents for the particular supplier, and
b) a part number detail document add/change file including any new part number detail documents and any changed part number detail documents compared to a last generation of the part number detail document file for the particular supplier; and
a communicator for communicating the part number detail document file and the part number detail document add/change file to the particular supplier.

12. The system of claim 11, wherein the communicator ensures receipt by the particular supplier by receiving an electronic acknowledgement from the particular supplier.

13. The system of claim 11, wherein the file generator includes:
a data extractor for extracting all part number detail data for the particular supplier from the part number library database;
a comparator for comparing the part number detail data to a previous extract of all part number detail data for the particular supplier to determine any new part number detail documents and any changed part number detail documents; and
a file generating module for generating the part number detail document add/change file based on a comparator output.

14. The system of claim 13, wherein, in the case that the comparator determines that no part number detail data changes or additions are present, then the file generator module generates an empty part number detail document add/change file.

15. The system of claim 11, wherein the part number detail document file includes: supplier name, supplier part number, enterprise contact, enterprise part number, part type, any customization requirement, at least one specification and an add/change date.

16. A program product stored on a computer-readable medium, which when executed, communicates part data between an enterprise and a particular supplier of a plurality of suppliers to the enterprise, the enterprise including a part number library database, the part number library database including part number detail data regarding a plurality of parts to be procured from the plurality of suppliers, the program product comprising:
program code for generating, using the part number library database, a part number detail document file including all part number detail documents for the particular supplier;
program code for generating a part number detail document add/change file including any new part number detail documents and any changed part number detail documents compared to a last generation of the part number detail document file for the particular supplier; and
program code for communicating the part number detail document file and the part number detail document add/change file to the particular supplier.

17. The program product of claim 16, wherein the communicating code further ensures receipt by the particular supplier by receiving an electronic acknowledgement from the particular supplier.

18. The program product of claim 16, wherein the generating code includes:
program code for extracting all part number detail data for the particular supplier from the part number library database;
program code for comparing the part number detail data to a previous extract of all part number detail data for the particular supplier to determine any new part number detail documents and any changed part number detail documents; and
program code for generating the part number detail document file and the part number detail document add/change file.

19. The program product of claim 19, wherein, in the case that the comparing code determines that no part number detail data changes or additions are present, then the file generating code generates an empty part number detail document add/change file.

20. A method of maintaining part data for a supplier to an enterprise, the method comprising the steps of:
receiving, at the supplier, a part number detail document file including all part number detail documents for the supplier and a part number detail document add/change file including any new part number detail documents and any changed part number detail documents from a last communication of the part number detail document file; and
updating the part data at the supplier based on the part number detail document file and the part number detail document add/change file.
